(19) United States
(12) Patent Application Publication
(10) Pub. No.: US 2025/0231631 A1
(43) Pub. Date: Jul. 17, 2025

(54) DEVICE FOR INTERACTION WITH A USER IN A MOTOR VEHICLE, AND MOTOR VEHICLE

(71) Applicant: AUDI AG, Ingolstadt (DE)

(72) Inventors: Siddharth ODEDRA, Munich (DE); Sebastian GEHWOLF, Munich (DE); Sophie SEVERIN, Ingolstadt (DE); Bartos SCHARMACH, Munich (DE)

(73) Assignee: AUDI AG, Ingolstadt (DE)

(21) Appl. No.: 19/027,035

(22) Filed: Jan. 17, 2025

(30) Foreign Application Priority Data
Jan. 17, 2024 (DE) 10 2024 101 362.1

(51) Int. Cl. G06F 3/041; B60K 35/10; B60K 35/22

(52) U.S. Cl. CPC G06F 3/041; B60K 35/10; B60K 35/22; B60K 2360/1438

(57) ABSTRACT

In an example, a device for interaction with a user in a motor vehicle may include an interaction unit arranged in an interior of a motor vehicle and which is configured to provide an interaction with the user. The interaction unit is configured to modify a degree of interaction of the interaction unit in response to a user input.

### CROSS-REFERENCE TO RELATED APPLICATIONS

This application claims the priority benefit of German Patent Application No. 10 2024 101 362.1 filed on Jan. 17, 2024, which is incorporated by reference herein in its entirety.

### BACKGROUND

### 1. Field

The exemplary embodiments of the invention may relate to a device for interaction with a user in a motor vehicle, and to a motor vehicle with such a device.

### 2. Description of the Related Art

Devices for user interaction in a motor vehicle are often static and cannot be adapted to the needs of a driver.

### SUMMARY

The described exemplary embodiments of the present invention may therefore provide an improved device for interaction with a user in a motor vehicle.

The described exemplary embodiments may be the subject matter of the independent claims. Advantageous developments may be specified in the dependent claims.

According to a first aspect, a device for interaction with a user in a motor vehicle may be provided.

The device here includes an interaction unit which may be arranged in an interior of a motor vehicle and which may be configured to provide an interaction with a user; wherein the interaction unit may be configured to modify a degree of interaction of the interaction unit in response to a user input.

In an example, the device may serve to provide a personalizable and emotional interaction option for a user of a motor vehicle.

The interaction unit, which can also be referred to as an avatar and/or a companion to the device, thus provides both a conversation and a source of information for the user and may be configured to interact with further components and/or units of the motor vehicle such as, for example, a display unit and/or an input unit and/or to access the latter, and vice versa, to enable integrated interaction with the user.

For this purpose, the device has an interaction unit which is arranged in an interior of a motor vehicle.

The interaction unit may be arranged at a central location in the interior, for example on or in the instrument panel, for example in the middle or centrally in the direction of travel. The interaction unit may be arranged so that it is spaced apart and physically separated from a central display unit, which can also be referred to as an infotainment system and/or CID (central information display), and may be distinct therefrom but can also optionally be connected thereto by signals.

The interaction unit may be configured to provide an interaction with a user of the motor vehicle.

An interaction includes, for example, communication with a user, for example, by providing audio content, video content, and/or movement content to the user and/or by receiving audio inputs and/or touch inputs from the user.

In order to provide or enable this interaction with the user and in particular to provide the functions described below of the interaction unit and/or the device, the interaction unit and/or the device can include one or more computer implemented processor units (computer processors), data processing units (computer data processors), and/or storage units (computer storage) on which program code may be stored, and/or can access them.

For example, the interaction unit may be configured to receive a voice input from the user and/or to output a voice output to the user. For this purpose, the interaction unit and/or the device can include one or more microphone units which are arranged, for example, in the interior of the motor vehicle and/or can access them. The interaction unit and/or the device can also include further apparatuses, and/or units and/or can access them in order to provide further types of interaction with the user, as will be described below.

The user of the interaction unit is here a passenger and/or a driver of the motor vehicle. The user may be a person who is sitting in the driver's seat and/or front passenger seat of the motor vehicle. It is also possible that two or more users interact simultaneously with the device and in particular the interaction unit may be configured to distinguish between who is interacting with the interaction unit, as will be described below.

For example, the user makes a voice request to the interaction unit and the interaction unit responds to this voice request.

The voice request can here include, for example, a function, a state, and/or a status of the motor vehicle. For example, the user can request a current driving speed, a distance traveled, and/or driving time, and/or a distance and/or driving time to a destination, or a state of an energy store of the motor vehicle.

The voice request can also be connected with a functional actuation of the motor vehicle or can include this. For example, the voice request can be a prompt to operate a specific function of the motor vehicle, for example playing or stopping a specific piece of music, music station, and/or music channel, and/or a playback volume.

The interaction can here be triggered by one or more signals and/or interaction prompts of the user. For example, the interaction can be initiated by providing a voice request of the user. This can take place for example by a specific codeword such as, for example, “Hey Audi” or “Hey avatar”, which can also be personalizable by a user.

The interaction unit may be configured to modify a degree of interaction of the interaction unit in response to a user input.

The interaction unit may be configured to receive and process an input of the user which defines or modifies a degree of interaction of the interaction unit. The degree of interaction is here a degree or a level of the extent to which or how strongly and/or how often the interaction unit interacts with the user. In particular, the degree of interaction can include whether the interaction unit can or needs to interact at all with the user and/or what an interaction with the user can and/or should trigger, as will be described below.

The user input can be, for example, a voice input or also a touch input, as will be described below.

The device makes it possible to provide a personalizable and emotional interaction option for a user of a motor vehicle.

According to an example, the degree of interaction includes one or more of a degree of connectivity, a degree of activity, and/or a degree of monitoring.

The degree of interaction which can be set by the user can include, for example, a degree of connectivity. A degree of connectivity is here a level of whether and to what extent the device or the interaction unit may be configured to access resources which are arranged outside the motor vehicle and/or to access a device distinct from the motor vehicle.

For example, the degree of connectivity includes the use or extent of use or the disabling of near field communication connections such as, for example, BLUETOOTH, and in particular access and the extent thereof to a mobile device, for example of the user, which is situated in particular in the motor vehicle.

Likewise, the degree of connectivity includes the use or extent of use or the disabling of data communication connections such as, for example, access to the Internet and/or a network storage such as, for example, the Cloud, for example by mobile communication, a WLAN, and/or Car2X.

For example, the device or the interaction unit can call up weather information from the Internet in the case of an activated or high degree of connectivity.

The degree of interaction which can be set by the user can also include, for example, a degree of activity. A degree of activity, which can also be referred to as a degree of responsivity and/or a degree of frequency, is here a level of whether and to what extent the device or the interaction unit interacts at all with the user or what an interaction can trigger or initiate.

For example, a high degree of activity can include that the user is spoken to or interacted with frequently and in particular also unprompted, for example with no previous user request, interaction, and/or prompt. For example, the user can be spoken to or interacted with based on another event such as, for example, opening and/or closing of a door, in particular the driver's door, starting of the engine and/or ignition of the motor vehicle and/or even for no specific reason or periodically, regularly, and/or after a predetermined period of time has passed, in particular of non-interaction.

Likewise, a low or small degree of activity can include, for example, that the user is not spoken to or interacted with umprompted or is so only after a user request, interaction, and/or prompt.

The degree of interaction which can be set by the user can also include, for example, a degree of monitoring. A degree of monitoring, which can also be referred to as a degree of tracking, is here a level of whether and to what extent the device and/or the interaction unit may be configured to follow or record the user behavior and in particular to react thereto and/or to use the device and/or the interaction unit for an interaction.

For example, past user actions such as most recently visited destinations, driving time, driving behavior, specific use of apps, for example on a mobile device and/or in the motor vehicle, can be monitored, and based thereon be an interaction.

For example, the device and/or the interaction unit can in the case of an activated or high degree of monitoring take a previous destination, such as a restaurant, as a reason to begin an interaction and to ask the user about the restaurant visit.

This development enables a particularly personalizable interaction which can be adapted to the occupancy situation of the motor vehicle.

According to an example, the interaction unit includes a display apparatus which may be configured to provide an interaction with the user.

The display apparatus may be included in the interaction unit and for example in a display unit of the motor vehicle on which comprehensive motor vehicle information such as, for example, a map or navigation, music playback, interior climate control, and/or motor vehicle settings may be displayed, and which can also be included in the device, distinct and for example spaced apart therefrom. The term motor vehicle information, or just information, is used in the present document with both a plural and singular sense and means that both a single piece of information and several pieces of information can be included.

In particular, the display apparatus of the interaction unit may be a smaller display and/or a display with a lower resolution than the main display or the CID. For example, the display apparatus can be a display with fewer than 20×200, 100×100, and/or 50×50 pixels.

In particular, the display apparatus can also be a display which can be black and white only. Alternatively, the display apparatus can, however, also be configured with a color display.

The display apparatus can here be used as an alternative to or in addition to the above-described voice interaction. For example, the interaction unit can receive a voice request of the user and provide, in particular exclusively, an answer on the display apparatus. Alternatively or additionally, the interaction unit can receive a voice request of the user and provide a voice output, wherein information which is additional to and/or redundant in the voice output is provided on the display apparatus.

In particular, the interaction unit can also be configured to display its currently set degree of interaction, for example by graphics and/or animation.

For example, a crossed-out radio symbol can be displayed when a degree of connectivity is low or switched off, a crossed-out ear displayed when a degree of monitoring is low or switched off, and/or a face with closed eyes and “ZZZ” may be displayed when a degree of activity is low or switched off.

Again, a radio symbol can, for example, be displayed when a degree of connectivity is high or switched on, an ear displayed when a degree of monitoring is high or switched on, and/or a face with open eyes and/or regular or periodic animation, for example of a moving and/or pulsing dot or circle, displayed when a degree of activity is high or switched on.

The interaction unit can also be configured to provide a notification of a necessary interaction and/or a vehicle message, in particular one which demands an interaction or a reaction of the user such as, for example, a hazard alert and/or a notification. This can be effected in particular by a question mark and/or an exclamation point which is displayed on the display apparatus.

The display apparatus can be configured in such a way that it can display a multidimensional symbol, image, or animation, for example by a multiple layered and/or partially transparent display. This example enables particularly informative interaction.

According to an example, the interaction unit may be configured to determine where the user with whom it is interacting is situated in the interior and, in response thereto, to direct the interaction to the user.

In particular, the device and/or the interaction unit may be configured to establish which user is currently interacting with it and/or where this user is situated or where they are sitting.

For this purpose, the device and/or the interaction unit can read seat occupancy, for example by way of one or more weight sensors in the seats, and/or to evaluate the sound from multiple microphone units in order to detect a direction and/or a position of the user who is currently interacting with the device and/or the interaction unit.

The interaction unit can then display, for example, a symbol and/or an animation on the display apparatus which is inclined or points in the direction of the user who is currently interacting with it. For example, a circle which indicates an interaction can move to the left-hand edge in the direction of travel when a person on the left-hand seat is interacting with the interaction unit, and to the right-hand edge in the direction of travel when a person on the right-hand seat is interacting with the interaction unit. This example enables particularly emotional interaction.

According to an example, the interaction unit includes a movement unit, wherein the movement unit may be configured to direct the interaction to the user.

The movement unit can here include one or more motors, in particular micromotors and/or servomotors, which may be configured to move the interaction unit in at least one plane, in particular to incline, rotate, and/or tilt it.

In particular, the movement unit can be configured to direct the interaction unit at the user who is currently interacting with it or to incline and/or rotate it in their direction. For example, the interaction unit can move toward the left-hand seat in the direction of travel when a person on the left-hand seat is interacting with the interaction unit, and toward the right-hand side in the direction of travel when a person on the right-hand seat is interacting with the interaction unit. This example enables particularly personal interaction.

Alternatively or additionally, the movement unit may be configured to provide an interaction both with and without being directed toward the user. In particular, the movement unit may be configured to indicate an interaction by a movement.

The movement can here be used for interaction as an alternative to or in addition to the above-described voice interaction and/or display apparatus. For example, the interaction unit can receive a voice request of the user and by a movement, in particular exclusively, provide an answer such as, for example, a downward nodding movement for “yes” and/or a shaking movement from left to right for “no”. Alternatively or additionally, the interaction unit can additionally receive a voice request of the user and provide a voice output, wherein information which is additional to and/or redundant in the voice output is provided by a movement.

In particular, the movement can also include a starting movement such as raising or moving upward, which is performed at the start of an interaction, in particular a first interaction, and/or when a degree of interaction is increased, and/or a stopping movement such as lowering or moving downward, which is performed at the end of an interaction and/or when a degree of interaction is reduced. This example enables a particularly noticeable interaction.

According to an example, the interaction unit includes a personalization unit which may be configured to provide a user preference for the interaction unit.

The personalization unit can here include information which includes a preference of the user and provide the user preference to the interaction unit. For example, the user preference includes a specific setting such as, for example, to provide or to include a color scheme, a movement scheme, an animation scheme, and/or a display scheme for the interaction unit.

The personalization unit can also provide a user preference for other components of the motor vehicle such as, for example, a central display unit or the CID, interior lighting and/or external lighting and to provide the user preference to the motor vehicle via the personalization unit. This example enables a particularly personalized interaction.

According to an example, the personalization unit is replaceable.

In particular, the personalization unit may be arranged on the interaction unit or included in the interaction unit in such a way that the personalization unit can be removed or arranged with one hand. For example, the personalization unit may be configured as a slide which can be pushed into a socket or slot provided for this purpose and can be detached therefrom. In particular, engagement elements which enable a sliding engagement can be provided at the personalization unit and the interaction unit.

In an example, the personalization unit may be configured as wireless such that the user preference can be transmitted wirelessly to the interaction unit when the personalization unit has been arranged thereon or mounted therein. For example, the personalization unit may be configured to communicate with the interaction unit with the aid of near field communication, for example NFC, RFID, and/or BLUETOOTH, and thus to provide the user preference. This example enables particularly simple personalization.

According to an example, the interaction unit may be configured to receive a touch input of the user.

The interaction unit can be configured to receive a touch input. For this purpose, the display apparatus can in particular be configured as a touchscreen in order to receive and process a touch from the user. Alternatively or additionally, an input apparatus can be provided such as, for example, a touchpad on which a touch input can be provided.

In an example, the interaction unit can be configured to perform one or more functions via a touch input, in particular one of the abovementioned ones. For example, the interaction unit may be configured to initiate an interaction in response to the receipt of a touch input, to modify a degree of connectivity, and/or to provide an interaction with the interaction unit.

In an example, different touch inputs are provided for different functions or different touch inputs effect different functions. In an example, the interaction unit may be configured to detect and distinguish between different types of touch inputs such as, for example, typing, tapping, holding, pressing, moving, duration of the input, and/or whole gestures and/or drawings and to perform a different function on the basis thereof.

For example, the interaction unit may be configured to distinguish between swiping and typing. Alternatively or additionally, the interaction unit may be configured to distinguish between a touch with one finger and or more than one, for example two, fingers. This examples enables particularly fast interaction.

According to an example, the interaction unit may be configured to provide the touch input of the user to a display unit which is arranged spaced apart from the interaction unit in the interior of the motor vehicle.

The display unit, which can also be referred to as a CID as described above, is here arranged in particular further away from the user than the interaction unit in the interior and is configured as separated therefrom.

The interaction unit here receives a touch input and provides it or the content thereof to the display unit, where a function can be performed on the basis thereof.

For example, the user can indicate by a touch input such as, for example, a swiping gesture from left to right on the interaction unit that they would like to trigger a change in the display content of the display unit and this change is then performed at the display unit.

Likewise, the user can, for example, provide a drawing such as, for example, a heart at the touch input, whereupon a piece of music that is currently being played is added to the favorites. This example enables particularly interactive interaction.

The device according to the described examples of the invention can also include the above-described display unit. In particular, the display unit can be configured such that it includes a first display section which is configured to display a first piece of motor vehicle information, and a second display section which is configured to display a second piece of motor vehicle information, wherein at least the first piece of motor vehicle information is personalized based on user behavior.

Additionally or alternatively, the device can also include an input unit which is arranged spaced apart from the display unit in the interior of the motor vehicle, and a first input element, wherein the input unit may be configured to display reduced first information content, corresponding to the motor vehicle information displayed on the display unit, at the first input element, to receive a first touch input of a user at the first input element, and to perform a function, corresponding to the first touch input, in the motor vehicle.

According to a further aspect, a motor vehicle is provided, including a device for interaction with a user according to one of the preceding exemplary embodiments.

The motor vehicle according to the examples of the invention may be in the form of a motor vehicle, for example, a car or truck, or a minibus or motorcycle.

In an example, the motor vehicle can be an at least a partially autonomous vehicle in which acceleration, braking, and/or steering actions are performed at least partially autonomously, i.e. without the involvement of a driver, by the motor vehicle, for example by a driving computer. This can be an autonomous driving mode of level 3, 4, 5 or above.

The device according to the examples of the invention may be configured to be operated in an autonomous driving mode of level 3, 4, 5 or above, in an example, exclusively.

The invention also includes the combinations of the features of the exemplary embodiments described. The invention thus also includes exemplary embodiments which in each case have a combination of the features of several of the exemplary embodiments described, provided that the exemplary embodiments have not been described as mutually exclusive.

### BRIEF DESCRIPTION OF DRAWINGS

Exemplary embodiments of the invention are described below, in which:

FIG. 1 shows a front view of an exemplary embodiment of a device for interaction with a user in a motor vehicle;

FIG. 2 shows a perspective detailed view of the device from FIG. 1; and

FIG. 3 shows a perspective exploded view of the device from FIG. 1.

### DESCRIPTION

The exemplary embodiments explained below are preferred embodiments of the invention. In the exemplary embodiments, the described components of the embodiments constitute in each case individual features of the invention which are to be considered as independent of one another and which in each case also develop the invention independently of one another. It is therefore intended that the disclosure also includes combinations of the features of the embodiments other than those illustrated. Furthermore, the embodiments described can also be supplemented with further of the already described features of the invention.

In the Figures, the same reference signs designate in each case elements with the same function.

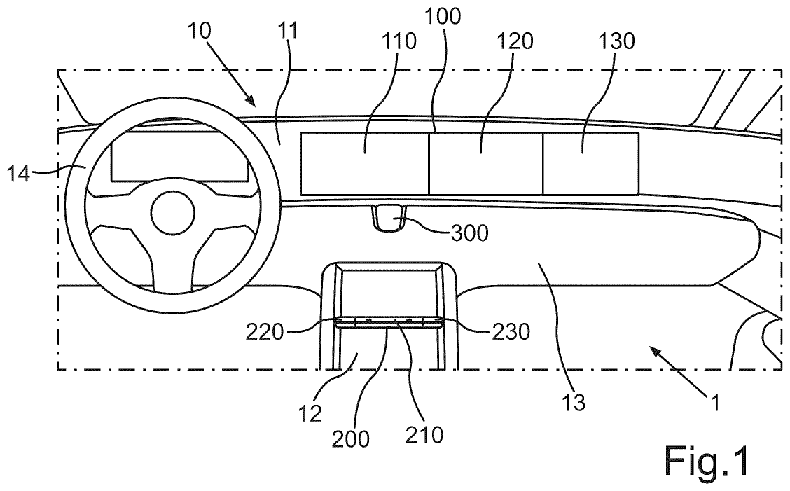

FIG. 1 shows a front view of an exemplary embodiment of a device 1 for interaction with a user in a motor vehicle.

The device 1 here includes a display unit 100 which is arranged in an interior 10 of the motor vehicle and which may be configured to display motor vehicle information.

The display unit 100 is here arranged in an upper part 11 of an instrument panel in the motor vehicle and extends essentially over at least half the width of the interior 10.

The display unit 100 includes a first display section 110 which may be configured to display a first piece of motor vehicle information, a second display section 120 which may be configured to display a second piece of motor vehicle information, and a third display section 130 which may be configured to display a third piece of motor vehicle information, wherein the first, second, and third display sections may be arranged next to one another.

At least the first piece of motor vehicle information may be personalized on the basis of user behavior.

A left-hand-drive motor vehicle with a steering wheel 14 on the left-hand side in the direction of travel is shown by way of example here, wherein the first display section 110 is arranged closer to the steering wheel 14 and hence to a user who is sitting on a driver's seat which is not shown in detail here, and the third display section 130 is situated furthest away.

The display unit 100 may be configured to detect a touch input of the user on one of the display sections and to modify the motor vehicle information in response to a touch input. In particular, the display unit 100 may be configured, in response to a touch input such as, for example, a swiping gesture, in particular from right to left, to swap the first piece of motor vehicle information and the second piece of motor vehicle information or to scroll through motor vehicle information shown on the first, second, and third display section.

The first display section 110 may have more motor vehicle information than the second display section 120, and the second display section 120 more motor vehicle information than the third display section 130.

The motor vehicle information displayed on the first, second, and/or third display section may have multiple hierarchical levels, wherein the motor vehicle information displayed in the first display section 110 includes at least one piece of motor vehicle information from a lower hierarchical level.

The device 1 also includes an input unit 200 which may be arranged spaced apart from the display unit 100 in the interior of the motor vehicle and includes a first input element 210, a second input element 220, and a third input element 230.

The input unit 200 may be arranged in a central console 12 of the interior 10 and may be arranged closer to a driver sitting on the driver's seat than the display unit 100 and also the interaction unit 300 described below.

The input unit 200 may be configured to display reduced first information content, corresponding to the motor vehicle information displayed on the display unit 100, at the first input element 210, to display reduced second information content, corresponding to the motor vehicle information displayed on the display unit 100, at the second input element 220, and to display reduced third information content, corresponding to the motor vehicle information displayed on the display unit 100, at the third input element 230.

The input unit 200 may be configured to receive a first touch input of a user at the first input element 210 and to perform a function corresponding to the first touch input in the motor vehicle, to receive a second touch input at the second input element 220 and to perform a function corresponding to the second touch input in the motor vehicle, and to receive a third touch input at the third input element 230 and to perform a function corresponding to the third touch input in the motor vehicle.

The reduced first, second, and/or third information content can be configured by the user.

The input unit 200 may be configured to distinguish between different types of touch inputs of the user at the first, second, and/or third input element and to perform different functions in the motor vehicle on the basis thereof.

The type of the first touch input can here in particular also differ from the type of the second touch input and the type of the third touch input.

The device 1 also includes an interaction unit 300 which may be arranged in the interior 10 of the motor vehicle and which may be configured to provide an interaction with a user. The interaction unit 300 may be arranged centrally in a lower part 13 of instrument panel, between the display unit 100 and the input unit 200.

The interaction unit 300 may be configured to modify a degree of interaction of the interaction unit 300 in response to a user input.

The degree of interaction here includes one or more of a degree of connectivity, a degree of activity, and/or a degree of monitoring.

The interaction unit 300 further may include a display apparatus which for reasons of visibility is not provided here with a reference sign and which may be configured to provide an interaction with the user.

The interaction unit 300 may be configured to determine where the user with whom it is interacting is situated in the interior and, in response thereto, to direct the interaction to the user.

For this purpose, the interaction unit 300 may include a movement unit, likewise not provided with a reference sign, which may be configured to direct the interaction to the user.

The interaction unit 300 may also include a personalization unit, likewise not provided with a reference sign, which may be configured to provide a user preference for the interaction unit 300, wherein the personalization unit is replaceable.

The interaction unit 300 may be configured to receive a touch input of the user at the display apparatus and to provide the touch input of the user to the display unit 100.

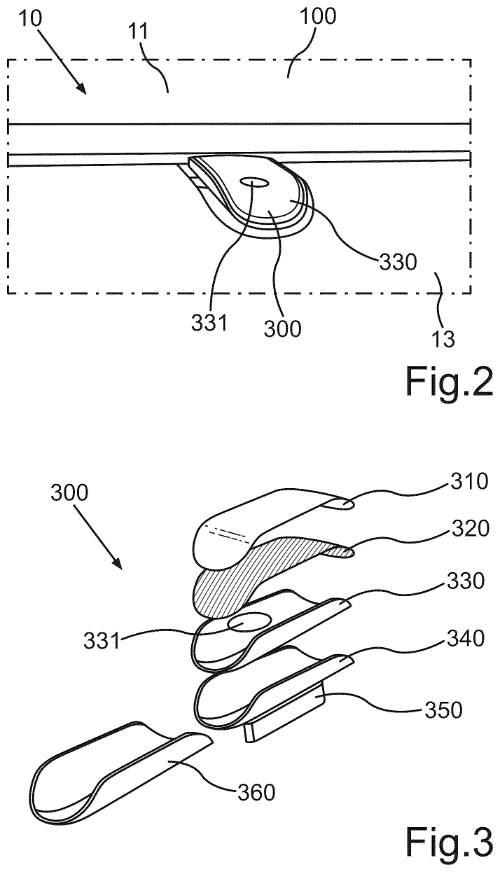

FIG. 2 shows a perspective detailed view of the device 1 and the interaction unit 300 from FIG. 1. It can in particular be seen here that the interaction unit 300 includes a display apparatus 330 which may be configured to provide an interaction with the user. Illustrated here by way of example is interaction content 331 in the form of a circle which may be configured to be directed toward the user with whom the interaction unit 300 is interacting.

FIG. 3 shows a perspective exploded view of the interaction unit 300 from FIG. 1.

In particular the individual components of the interaction unit 300 can be seen here. They include, from top to bottom, a piece of protective glass 310 which can include, for example, bonded glass, a touch surface 320 which may be configured to receive and process touch inputs, a display apparatus 330 which may be configured to display interaction content, a processor unit 340 which may be configured to perform the functions of the interaction unit, and a movement unit 350 which may be configured to move the interaction unit 300 and for example to direct the interaction unit to the user with whom the interaction unit is interacting.

Also shown is the replaceable personalization unit 360 which may be configured to provide a user preference for the interaction unit 300. The personalization unit may be configured as a slide which can be brought into engagement with the interaction unit 300 by a sliding movement in the direction S.

Taken as a whole, the examples show how an avatar can be provided for emotional interaction in a motor vehicle.

A description has been provided with particular reference to examples, but it will be understood that variations and modifications can be effected within the spirit and scope of the claims, which may include the phrase “at least one of A, B and C” as an alternative expression that refers to one or more of A, B or C, contrary to the holding in Superguide v. DIRECTV, 358 F3d870, 69 USPQ2d1865 (Fed. Cir. 2004).

1. A device to interact with a user in a motor vehicle, comprising:
an interaction unit arranged in an interior of the motor vehicle and configured to provide an interaction with a user;
wherein the interaction unit is configured to modify a degree of interaction of the interaction unit in response to a user input.

2. The device according to claim 1,
wherein the degree of interaction includes one or more of a degree of connectivity, a degree of activity, and/or a degree of monitoring.

3. The device according to claim 1,
wherein the interaction unit includes a display apparatus which is configured to provide an interaction with the user.

4. The device according to claim 1,
wherein the interaction unit is configured to perform a determination of where the user with whom the interaction unit is interacting is situated in the interior and, in response to the determination, to direct the interaction to the user.

5. The device according to claim 4,
wherein the interaction unit includes a movement unit, and wherein the movement unit is configured to direct the interaction to the user.

6. The device according to claim 1,
wherein the interaction unit includes a personalization unit which is configured to provide a user preference for the interaction unit.

7. The device according to claim 6, wherein the personalization unit is replaceable.

8. The device according to claim 1,
wherein the interaction unit is configured to receive a touch input of the user for the interaction.

9. The device according to claim 8,
wherein the interaction unit is configured to provide the touch input of the user to a display unit arranged spaced apart from the interaction unit in the interior of the motor vehicle.

10. A motor vehicle, comprising:
a device to interact with a user in the motor vehicle, the device including
an interaction unit arranged in an interior of the motor vehicle and configured to provide an interaction with a user,
wherein the interaction unit is configured to modify a degree of interaction of the interaction unit in response to a user input.

11. The motor vehicle according to claim 10, wherein the degree of interaction includes one or more of a degree of connectivity, a degree of activity, and/or a degree of monitoring.

12. The motor vehicle according to claim 10,
wherein the interaction unit includes a display apparatus which is configured to provide an interaction with the user.

13. The motor vehicle according to claim 10,
wherein the interaction unit is configured to perform a determination of where the user with whom the interaction unit is interacting is situated in the interior and, in response to the determination, to direct the interaction to the user.

14. The motor vehicle according to claim 13,
wherein the interaction unit includes a movement unit, and wherein the movement unit is configured to direct the interaction to the user.

15. The motor vehicle according to claim 10,
wherein the interaction unit includes a personalization unit which is configured to provide a user preference for the interaction unit.

16. The motor vehicle according to claim 15, wherein the personalization unit is replaceable.

17. The motor vehicle according to claim 10,
wherein the interaction unit is configured to receive a touch input of the user for the interaction.

18. The motor vehicle according to claim 17,
wherein the interaction unit is configured to provide the touch input of the user to a display unit arranged spaced apart from the interaction unit in the interior of the motor vehicle.
